(19) United States
(12) Patent Application Publication
(10) Pub. No.: US 2010/0127000 A1
(43) Pub. Date: May 27, 2010

(54) ENERGY SAVING COMPONENT

(75) Inventor: Tibor G. Horwath, Fredericksburg, VA (US)

Correspondence Address: WALTER L. BEAVERS, 326 SOUTH EUGENE STREET, GREENSBORO, NC, 27401, US

(73) Assignee: PHASE CHANGE ENERGY SOLUTIONS, INC., Grand Junction, CO (US)

(21) Appl. No.: 12/448,001

(22) PCT Filed: Jan. 17, 2008
(86) PCT No.: PCT/AT2008/000011

§ 371 Date: Jun. 3, 2009

Related U.S. Application Data
(60) Provisional application No. 60/880,945, filed on Jan. 18, 2007.

(51) Int. Cl. B65D 85/00; B32B 3/00

(52) U.S. Cl. 220/592.01; 156/77

(57) ABSTRACT

The invention described here provides different embodiments of a component part which exhibits high heat insulation and high heat energy storage for use in residential and industrial constructions. It is based on a latent heat storage by phase changes of particular materials in a temperature range equal to room temperature. The component part can be packaged in mats which are similar to films with air chambers (known as bubble wrap) used for packaging sensitive and fragile articles. Moreover, the component part can be rendered fire-resistant. In its most simple embodiment, it can bring about significant energy savings for heating and cooling when incorporated in walls, ceilings and floors of buildings. By integrating the material with geothermal heat pumps and solar collectors, said energy savings for heating and cooling can be increased by up to 80 percent, compared to conventional construction methods.

The present invention relates to a component part which can be used in building materials, particularly in building materials with high heat insulation and high energy storage, e.g. in building materials used in buildings with geothermal and/or solar heating and cooling.

Energy efficiency in buildings depends primarily on two material parameters of the exterior walls. One parameter is the thermal resistance or thermal conductivity of the material as characterized by the R-number or k-number. This parameter is also referred to as heat insulation which determines the heat flow through the walls of the building for both heating and cooling and, furthermore, the respective energy requirement for maintaining the desired inside temperature under different outside temperature conditions.

The other parameter is the heat storage capacity of the material. It affects the extent to which the inside temperature, without heating or cooling, follows the exterior temperature fluctuations. The heat storage capacity or “thermal mass” usually correlates with the physical mass of the material, which is the reason why buildings with thick external walls exhibit more stable temperature conditions in the interior than buildings constructed of light materials.

Recent advances in materials technology have rendered possible the production of materials which can store up to a hundred times more heat per unit of mass than conventional materials, in the temperature ranges of interest. In addition to the normal heat stored in the material, latent heat is stored due to a phase transition of the material. Such phase change materials (PCMs) are available for a wide range of phase change temperatures and are producible with a low weight and at low cost. Combined with heat insulating materials in a suitable arrangement, they can be used both for heat insulation and for heat storage.

A measure of the quality of such combined materials is the thermal time constant, which is the time for which the internal temperature of the material will remain unchanged if a temperature difference of one degree Celsius occurs on the outside. The value of said time constant for a present material combination depends on the properties of the heat storage material, the properties of the insulating material and the dimensions thereof in the direction of the heat flow. The values of the time constants are maximized when the thicknesses of the materials are equal.

High insulation properties of the wall material as well as high heat storage capacity are desirable for an increased energy efficiency but can hardly be achieved with conventional building materials, methods and practices. Since a limitation of the amount of building materials to the structurally required minimum is desirable from the standpoint of cost reduction, solid wall structures which, due to their mass, might be suitable for the storage of large amounts of heat are economically not feasible.

Conventional building materials with a high thermal mass, such as masonry, normally have low heat insulation properties. While heat insulation can be improved by the application of additional insulating layers, thermal mass can only be increased by more solid wall structures due to the heat storage properties of the material. Since conventional methods do not exploit synergies in the application of geothermal heat pumps, solar energy and energy-storing phase change materials, high installation and operating costs are thereby produced.

A component part for the construction of residential and public buildings with high heat storage has now surprisingly been found, which can be incorporated in walls, ceilings and floors of buildings where it can store the latent heat in the phase transition of a storage material and can thereby effectively increase the thermal mass of the building, without more solid building structures being necessary. The heat storage and emission takes place over significant portions of the day, which has a balancing effect and, at the same time, reduces the energy requirements for heating and cooling. The component part can, for example, be integrated into the climatization system of a building, e.g., in conjunction with a geothermal heat pump, whereby energy savings of up to 80 percent are possible under favourable circumstances. Furthermore, the component part is of low cost, easy to manufacture, and its constituent components are environmentally friendly.

According to the present invention, the following is provided:
energy storage for residential and commercial buildings,
energy storage for the construction of residential and commercial buildings,
energy storage for the retrofit of residential and commercial buildings,
energy storage for the retrofit of residential and commercial buildings, using phase change materials,
energy storage of environmentally safe and latent heat energy for the retrofit of residential and commercial buildings,
a (flexible) mat with individual voids (cells) filled with phase change material (PCM), e.g., for energy storage for the construction and retrofit of residential and commercial buildings, e.g., with the mat consisting of a film with air chambers (bubble wrap),
energy storage for the construction and retrofit of residential and commercial buildings in the shape of a (flexible) mat with individual voids (cells) filled with phase change material (PCM), with individual voids (cells) containing a fire retardant material,
energy storage for the construction and retrofit of residential and commercial buildings, which can be integrated in buildings equipped with heating and/or cooling systems for floors, ceilings and walls.

In one aspect, the present invention provides a container made of a material containing voids, which is characterized in that the voids are filled with a phase change material and sealed by a cover sheet.

Said container is here also referred to as “container(s) according to the present invention”.

A container according to the present invention is usable as a component part and includes films as well as mats and metal sheets.

Preferably, a container has the shape of an air cushion film (bubble wrap) in which voids corresponding to the air chambers are filled with a phase change material (PCM) and sealed by a cover sheet.

A container according to the present invention can be designed in the form of a, for example flexible, mat. A mat according to the present invention may have any width, e.g., a width of approx. 50 to 60 cm. A mat according to the present invention may be produced as a continuous roll.

A container according to the present invention constitutes an energy-storing container. In a container according to the present invention, it is not necessary that all voids are filled.

The voids may contain a material which keeps the phase change material absorbed in the liquid form so that no material can leak if the envelope is damaged, for example, an absorbent material such as, e.g., a sponge.

According to the present invention, a material containing voids comprises plastics, e.g. plastic from soft to hard, metal or composite, preferably plastic or metal.

A phase change material (PCM) according to the present invention is known and comprises a phase change material which, due to phase changes of particular materials, stores heat latently; preferably in a temperature range equal to room temperature, approximately at a temperature of from 20 to 35° C.

In a specific embodiment, the present invention provides a container according to the present invention which is made up of a flat cover sheet (13) and a carrier sheet with voids (11) containing a phase change material (12); as described and shown, e.g., in FIG. 1.

In a preferred embodiment, the container is an energy-storing mat (10) like the one described in FIG. 1, which is similar to the well-known packing and shipping material for sensitive and fragile articles which is known as “bubble wrap” (air cushion film). It consists of a flat carrier film (11) provided with voids, which is sealed by a flat cover film (13), which, optionally and preferably, is made of the same material, e.g. metal, glass or plastic, preferably plastic. The voids constitute energy storing cells when filled with the phase change material (PCM) (12). The cell sizes of the voids are chosen to be so large that enough material is contained so that the thermal time constant will reach the desired value when used in conjunction with a suitable insulating material. On the other hand, the cells should be sufficiently small so that a few punctures during installation or afterwards will not cause a significant reduction in the amount of PCM in order not to reduce the effectiveness. Normally, a cell size containing about one gram of phase change material appears to be optimum, which corresponds to a dimension of the voids of approximately one centimetre in diameter and height.

In a further aspect, the present invention provides a container according to the present invention in which voids are filled with a fire retardant material, for example, voids are filled either with a PCM or with a fire retardant material, or with a PCM and a fire retardant material.

In a further aspect, the present invention provides a container according to the present invention consisting of a flat cover film (24) and a carrier film with voids (21) containing a phase change material (22) and with voids containing a fire retardant material (23); as shown and described, e.g., in FIG. 2.

A variation of the above-described preferred embodiment is an energy-storing mat (20) in which voids, i.e., cells, are filled with the PCM and other voids are filled with a fire retardant material, or cells are filled with the PCM and a fire retardant material, as shown, for example, in FIG. 2. Also in that case, the mat is made up of a carrier film with voids (21) and a flat cover film (24). Fire extinguishing material is known and includes, for example, water. The configuration of the cells containing a fire retardant material can be more or less regular, with the particular configuration of the arrangement being more or less non-crucial as long as the ratio of the two fillings effectively meets the requirements of fire resistance. This will, of course, depend on the materials used. Thereby, the fire retardant material does not have to be contained in separate cells but can also be mixed with the PCM, provided that the two materials are chemically compatible and are embedded in the same cells.

The two preferred embodiments of an energy-storing mat as described are passive components, meaning that the heat energy stored is taken up from the immediate environment.

In a further aspect, the present invention provides a container according to the present invention which is heat-insulated, for example, with glass wool or rock wool, such as, e.g., a container according to the present invention which contains, in a sealed envelope, voids with a phase change material and optionally a fire retardant material which are surrounded by an integrated heat exchanger, preferably

a container according to the present invention which is made up of an insulating layer (35) onto which a carrier film with voids surrounded by an envelope (33) and containing a phase change material (32) is applied, with the voids being surrounded by a heat exchanger which enables the circulation of a heat carrier with a heat carrier inflow (31) and a heat carrier outflow (34) around the voids;
for example, as shown and described in FIG. 3.

In a further preferred embodiment, an energy-storing mat (30) is connected to a heat exchanger and a heat insulating layer, as described, e.g., in FIG. 3. In this case, the heat stored in the cells comes directly from the heat carrier fluid circulating between the cells.

Such a configuration is achieved by the application of a third film which seals the upper end and the edges of the voids (cells). This multilayer envelope (33) enables the heat carrier fluid to flow completely around the cells containing the PCM (32). Pipe sections for the heat carrier inflow (31) and outflow (34) are suited as a connection to the respective feed and discharge pipes. The entire arrangement may optionally also be provided with an insulating layer (35). Such an energy-saving mat can be of paramount importance for energy efficient construction techniques, wherein it is endeavoured to use the entire building structure as heating and cooling elements, respectively (building core climatization).

A wide variety of materials can be used for the manufacture of such energy-storing mats or plates, e.g., plastics (from soft to hard) or sheet metal. The latter may be more advantageous for some applications, such as for those comprising an integrated heat exchanger.

Containers according to the present invention are particularly suitable as component parts in the new construction or conversion of buildings such as residential or farm buildings. A mat according to the present invention can be used universally for new constructions or conversions in a timber frame construction, steel construction and in concrete and brick constructions. It is suitable for both external and internal walls, for the floor, the inserted ceiling and also for the roof. A mat according to the present invention can be used like an additional insulating layer and can also be used wherever an insulating layer is built in, whereby it is more efficient to apply the mat to the inside of the insulation: wall structure (from the outside to the inside): external material (e.g. wood, metal), insulating material (e.g. rock wool), PCM mat, afterwards a closing plate, e.g., a Rigips plate.

In a further aspect, the present invention provides the use of a container according to the present invention
as a component part, e.g., as an energy efficient component part, or
for the storage of energy.

In a further aspect, the present invention provides a process for the manufacture of a container according to the present invention, which is characterized in that, in a carrier sheet, voids are produced in the carrier sheet by means of dimpling rollers and voids produced in this manner are filled with a fire retardant material and/or a phase change material, whereupon a cover sheet and a bottom sheet are optionally applied around the carrier sheet with the voids by means of fusion rollers, which is divided into appropriate pieces with the aid of a cutting device, the container optionally being heat-insulated and/or the voids optionally being surrounded by a heat exchanger, for example, a process for the manufacture of a container according to the present invention, which is characterized in that, in a carrier sheet (41), voids are produced in the carrier sheet by means of dimpling rollers (42), which voids are filled with a phase change material (43), whereupon a cover sheet (44) and a bottom sheet (45) are applied around the carrier sheet (41) with the filled voids by means of heated fusion rollers (46), whereby an energy-storing mat thus produced is divided into appropriate pieces with the aid of a cutting device (47), resulting in a container (49) having a final cross-section (48); as shown and described, for example, in FIG. 4.

A typical manufacturing process (40) for such energy-storing mats, as described above, is shown in FIG. 4. A carrier sheet (41) is guided through dimpling rollers (42), and the resulting voids (cells) are filled with PCM (43). The filled carrier sheet is linked to a cover sheet (44) and a bottom sheet (45) by means of heated fusion rollers (46) which combine the three plastic films and seal the edges accordingly, as shown in the final cross-section (48). A set of sharp blades (47) cut off the end product (49) in the desired length.

A typical climatization system (heating and cooling) for the construction of an energy efficient building using the energy-storing mats as described with integrated heat exchangers is shown schematically in FIG. 5. The energy efficient building (50) uses a geothermal heat pump (51) as the main energy supplier and solar collectors (55) as an auxiliary energy source which normally is mounted to a roof. A geothermal heat source (52) submerged in the ground, e.g., in a well, acts as an energy reservoir for both heating and cooling. The output of the heat pump is transferred to a heat carrier loop via a heat exchanger (53). The heat carrier fluid such as salt water, ethylene glycol or a heat carrier fluid with similar thermal properties circulates through the loops with the aid of a main circulating pump (54). A solar-operated circulating pump (56) causes the flow of the heat carrier fluid from the solar collectors (55), which is turned on and off by a solar shutoff valve (57) depending on the availability of solar heat. A control computer (58) processes the information from internal and external sensors and coordinates the various functions in an optimum manner. This arrangement also permits remote system monitoring, reprogramming and other system adjustments.

In a further aspect, the present invention provides a residential or industrial building which includes a container according to any of claims 1 to 5, for example, in a floor, roof or wall surface, optionally furthermore comprising
a geothermal heat pump, optionally computer-controlled,
an underground geothermal heat exchanger, if possible located in groundwater, for the supply or absorption of heat from said geothermal heat pump, which is connected, via a heat carrier fluid, to said geothermal heat pump, which supplies or withdraws heat,
an electrically operated circulating pump, optionally computer-controlled, for the circulation of the heat carrier fluid, which is connected to said geothermal heat pump via a heat exchanger; e.g., for the internal climatization of the building,
solar collectors for storing solar energy,
an electrically operated solar circulating pump, optionally computer-controlled, for the circulation of heat carrier fluid through the solar collector,
an electrically operated control valve, optionally computer-controlled, for switching on and off the solar cycle of the heat carrier fluid, and/or
sensors for internal and external temperatures for optimizing operating conditions and maximizing efficiency using a control computer, which optionally also performs diagnostic functions and optionally can be remote-programmed using a telephone modem.

A person skilled in the art is familiar with modifications and variations of the described embodiments which comply with the requirements and the environment. Thus, the present invention is not limited to the described examples but comprises all sorts of possible variations and modifications.

### DESCRIPTION OF THE DRAWINGS

FIG. 1 shows perspectively an energy-storing mat which is made up of a (flat) cover sheet (13) and a carrier sheet with voids (11) containing a latent heat-dependent energy-storing phase change material (12).

FIG. 2 shows perspectively an energy-storing mat containing a fire retardant material which is made up of a (flat) cover film (24) and a carrier film with voids (21) containing a latent heat-dependent energy-storing phase change material (22) and with voids containing a fire retardant material (23).

FIG. 3 shows perspectively an energy-storing mat comprising a heat exchanger and an insulating layer which is made up of an insulating layer (35) and voids surrounded by a multilayer envelope (33) and containing a latent heat-dependent energy-storing phase change material (32), with the voids being surrounded by an integrated heat exchanger which enables the circulation of a heat carrier with a heat carrier inflow (31) and a heat carrier outflow (34) around the voids.

FIG. 4 shows schematically a typical manufacturing process for an energy-storing mat such as the one shown in FIG. 3, wherein, in a carrier sheet (41), voids are produced in the carrier sheet by means of dimpling rollers (42), which voids are filled with a latent heat-dependent energy-storing phase change material (43), whereupon a cover sheet (44) and a bottom sheet (45) are applied around the carrier sheet (41) with the filled voids by means of heated fusion rollers (46), and an energy-storing mat thus produced, such as the one shown in FIG. 3, is divided into appropriate pieces with the aid of a cutting device (47). The end product (49) having a final cross-section (48) is thereby produced.

FIG. 5 shows schematically the concept of an energy efficient building which comprises
an energy-storing mat, e.g., according to any of FIGS. 1 to 4,
a geothermal heat source (52) and a geothermal heat pump (51) via which geothermal heat is supplied to the building via a main circulating pump (54) and a heat exchanger (53), and
solar collectors (55) via which solar heat is supplied to the building via a solar circulating pump (56), a solar shutoff valve (57) and via a heat exchanger (53),
with the heat supply being controlled by a control computer (58).

FIG. 6 A mat with a black interior film which can be used for a wall structure in a timber frame construction.

FIG. 7 A bottom PVC film in which the voids contain a sponge.

FIG. 8 A possible wall structure (from the outside to the inside): external material (e.g. wood, metal), insulating material (e.g. rock wool), PCM mat, afterwards a closing plate, e.g., a Rigips plate.

FIG. 9 The chart shows the effect in a passive application (without heating and without cooling): The temperature fluctuations between the lowest and the highest temperatures turn out to be smaller.

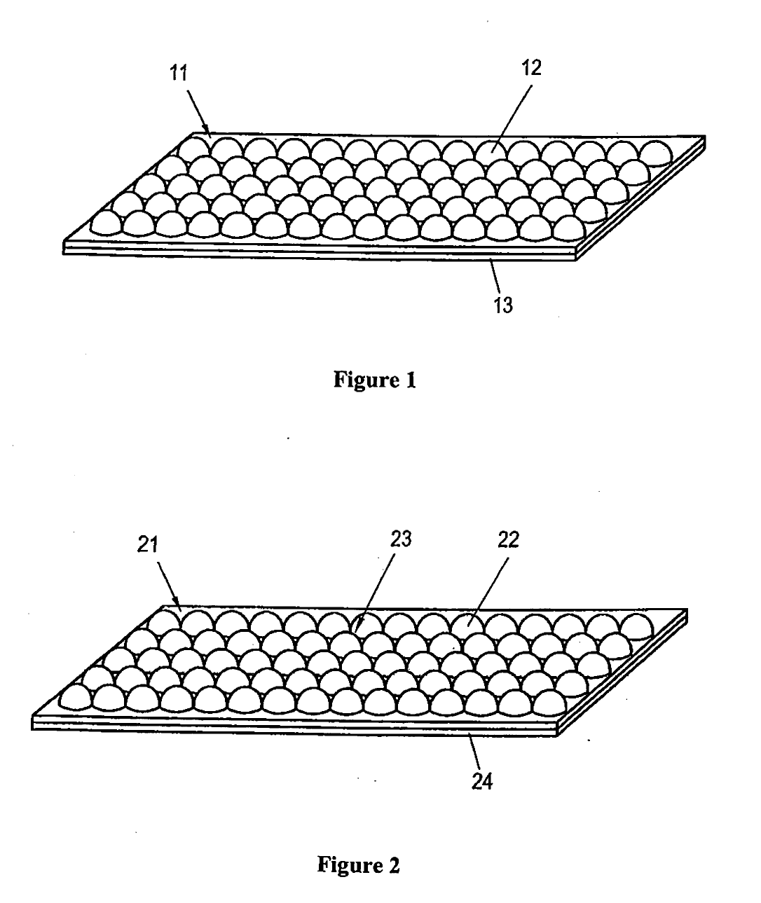

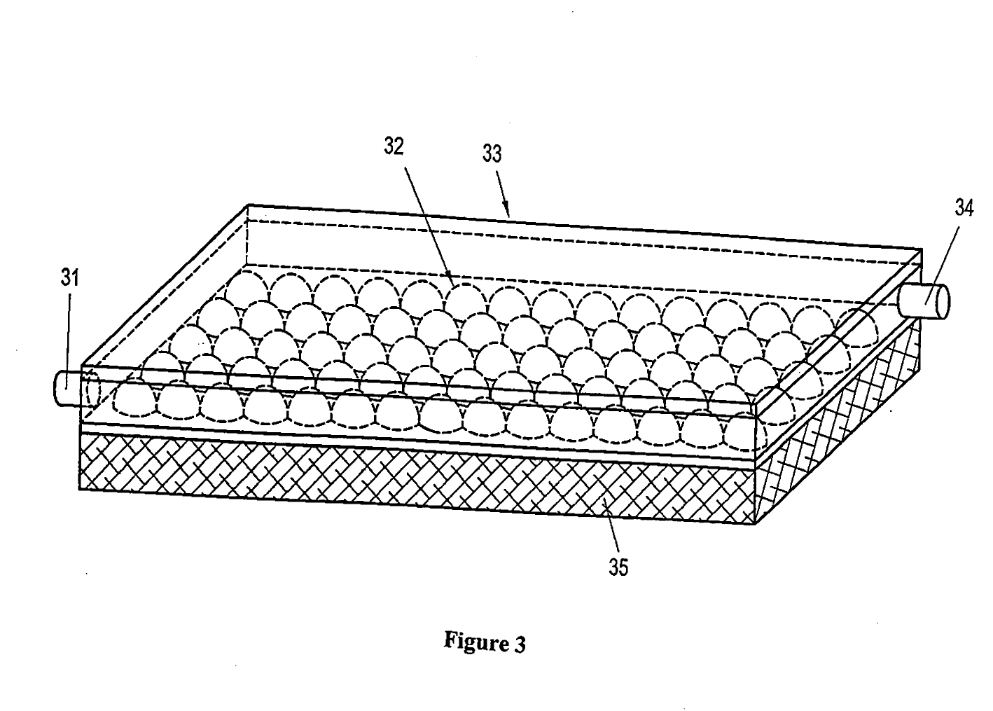

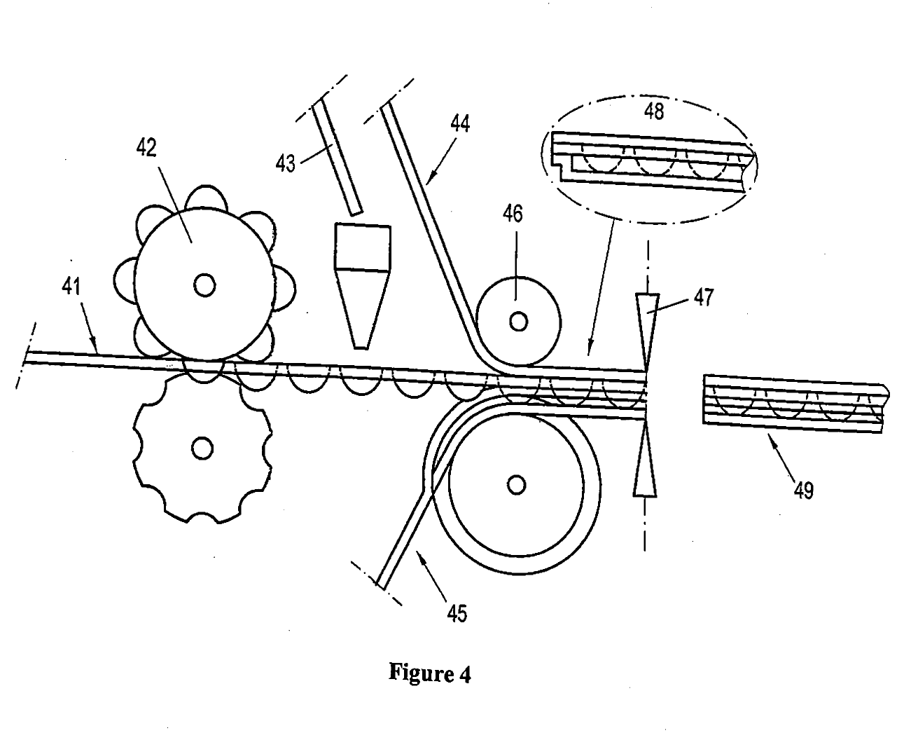

By the following example, a particular embodiment of the invention will be described in more detail.

### EXAMPLE

### Mat Containing a Phase Change Material

The mat consists of two PVC films which are sealed together. Between them, the phase change material, which is produced on the basis of either paraffin or soy, is shrink-wrapped into individual chambers (approx. 2 cm×3 cm×2 cm)—the size and height of the individual chambers can be increased or reduced if required—with a sponge, in addition, being located in each chamber, which sponge keeps the phase change material absorbed also in the liquid form so that no material can leak if the envelope is damaged.

The mat is produced as a continuous roll with a width of approx. 50 to 60 cm so that it can be processed like a wallpaper. The respective width will have to be adjusted depending on the intended use. Depending on the functional range and the climatic conditions, different phase change materials will be used, since, for different fields of application, different transition temperatures from the solid to the liquid phase will result in the optimum functioning of the mat. For living quarters, said temperature will be between 20 and 25° C. In order to improve the functioning even further, a white film is applied to the outside and a black film is applied to the inside.

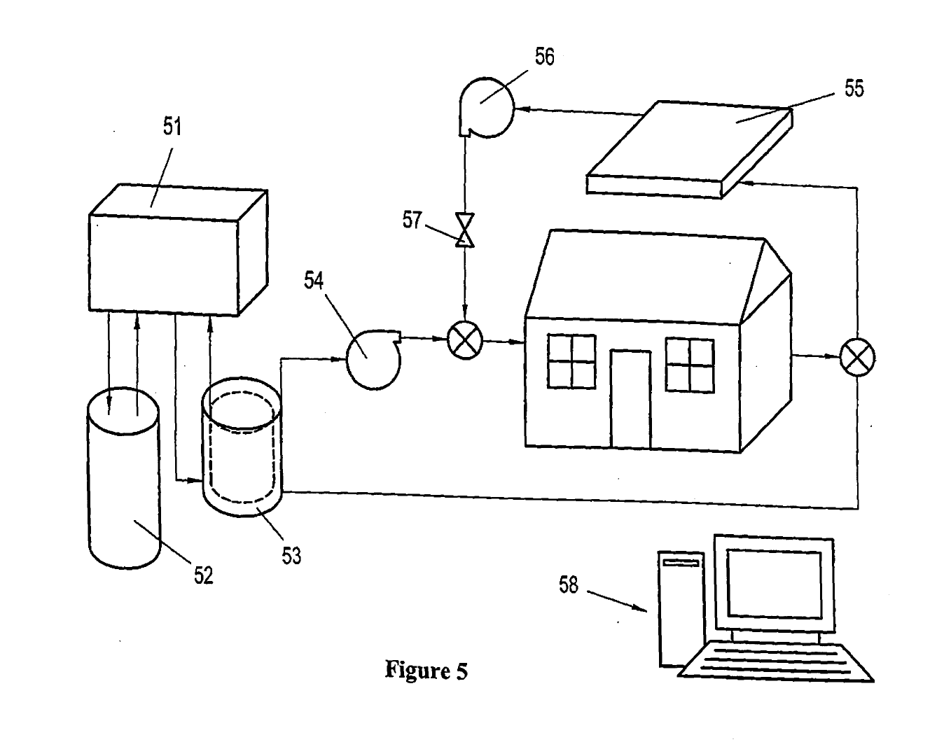

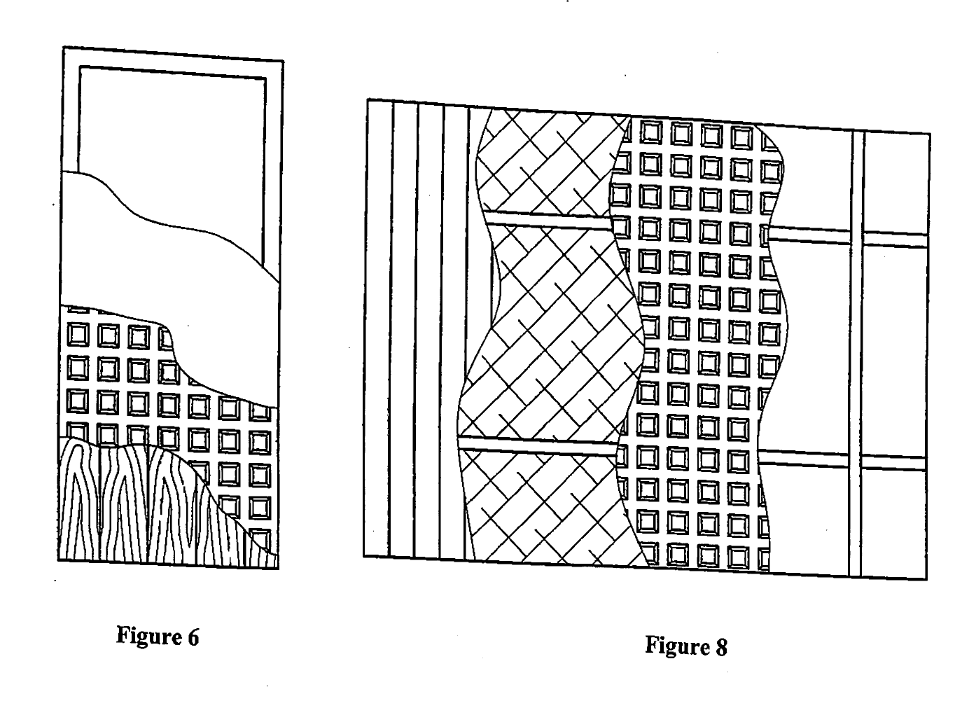

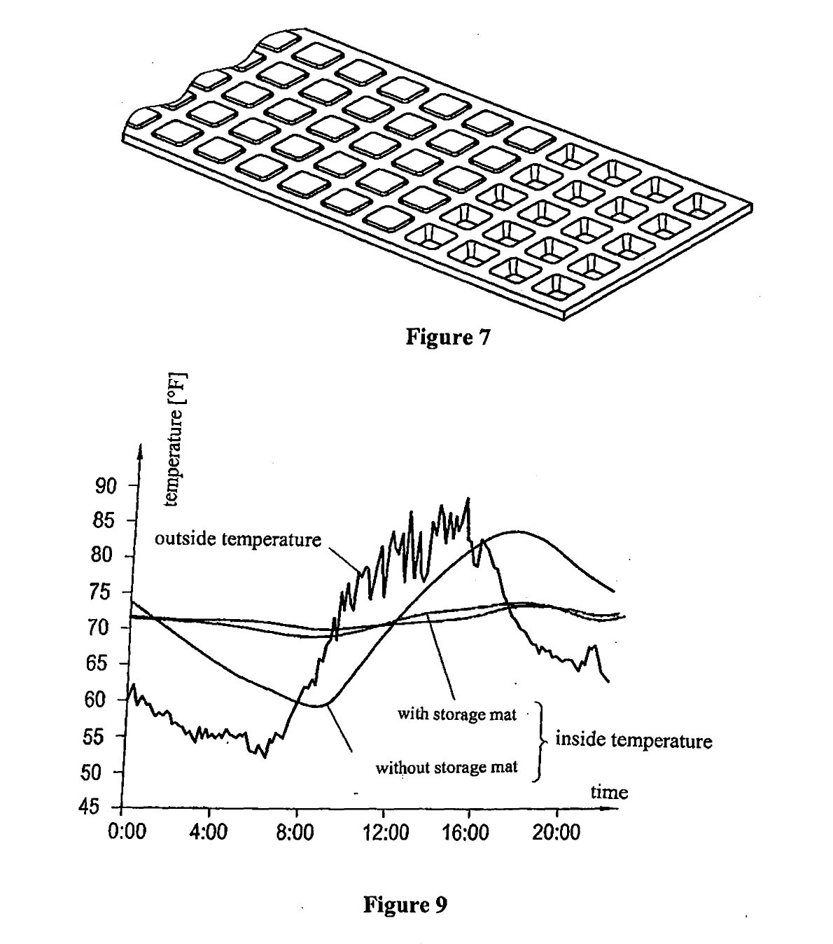

A mat with a black interior film which can be used for a wall structure in a timber frame construction is shown, for example, in FIG. 6. In FIG. 7, a bottom PVC film is shown, in which the voids contain a sponge.

The mat can be used in a timber frame construction, in a steel construction and in concrete and brick constructions. It is suitable for both external and internal walls, for the floor, the inserted ceiling and also for the roof. The mat is used like an additional insulating layer and can also be used wherever an insulating layer is built in, whereby it is more efficient to apply the mat to the inside of the insulation: wall structure (from the outside to the inside): external material (e.g. wood, metal), insulating material (e.g. rock wool), PCM mat, afterwards a closing plate, e.g., a Rigips plate, see, e.g., FIG. 8.

By installing the PCM mat in the wall and/or ceiling structure, respectively, room air conditions will improve owing to the fact that there are smaller temperature fluctuations between the lowest and the highest temperatures, and a lot of energy can be saved during both cooling and heating due to the heat storage and the shift in heat absorption and heat emission.

Mode of operation: As soon as the outside temperature rises, said heat is passed on to the external wall and, subsequently, will also be released into the inner space, which thereby is heated. That means: temperature rise on the outside=temperature rise on the inside. If the PCM mat is used, energy is required for converting the phase change material from the solid to the liquid state of matter. While here the outside temperature now also rises, the solid PCM material also heats up to its melting point. A very large amount of energy is now used for converting the material from the solid to the liquid state without the temperature of said material rising as well. The temperature can rise back up only after complete liquefaction. This causes a much smaller temperature rise in the interior than without a phase change mat. The opposite effect occurs when the outside temperature drops. As the temperature drops, the phase change material releases energy into the environment during solidification and thus reduces the cooling of the interior.

In a passive application (without heating and without cooling), the result of this effect is that the temperature fluctuations between the lowest and the highest temperatures turn out to be smaller. (See, e.g., the chart in FIG. 9).

In an active application (heating or air conditioning system), energy is saved owing to the fact that the heating or the air conditioning system, respectively, has to counterbalance just this small temperature difference.

1.-10. (canceled)

11. Container of a material that contains cavities which are filled with a phase change material and closed with a cover layer, characterized in that it possesses an insulating layer (35), whereon a carrier film with cavities, surrounded with a cover (33) and containing phase change material (32) is applied, wherein the cavities are surrounded by a heat exchanger which permits the circulation of a heat carrier via a heat carrier inlet (31) and a heat carrier outlet (34) around the cavities.

12. Container according to claim 11 in the form of a bubble wrap, wherein the bubble analogous cavities are filled with phase change material and closed with a cover layer.

13. Container according to claim 11 with a plane cover layer (13) and a carrier layer with cavities (11), which contain phase change material (12).

14. Container according to claim 11 with a plane cover film (24) and a carrier film with cavities (21), which contain phase change material (22), and with cavities which contain fire-retardant material (23).

15. Use of a container according to claim 11 as a construction element.

16. Use of a container according to claim 11 for the storage of energy.

17. Process for the manufacture of a container according to claim 11 characterized in that cavities in the carrier layer are generated by means of press-in rollers and such manufactured cavities are filled with fire-retardant material and/or phase change material, whereon optionally a cover layer and a lower layer are applied by means of melting rollers around the carrier layer with cavities, which is divided into suitable pieces by a cutting device, wherein the container is heat-insulated and the cavities are surrounded by a heat exchanger.

18. Process for the manufacture of a container according to claim 17, characterized in that the cavities in the carrier layer (41) are generated by means of press-in rollers (42) and are filled with phase change material (43) wherein a cover layer (44) and a lower layer (45) are applied by means of hot melting rollers (46) on the carrier layer (41) with the filled cavities, wherein the thereby manufactured energy-storing mat is divided into suitable pieces with a cutting device (47), resulting in a container (49) with an end cross section (48).

19. Residential or industrial building possessing a container according to claim 11 optionally further containing:
an optionally computer-controlled geothermic heat pump;
a subterranean earth heat exchanger, if possible located in ground water, for the delivery or collection of heat from said geothermic heat pump, which is connected with said geothermic heat pump by means of a heat transfer fluid delivering or withdrawing heat;
an optionally computer-controlled, electric driven circulating pump for the circulation of the heat transfer fluid, connected with said geothermic heat pump by means of a heat exchanger; e.g. for internal climatization of the building;
solar collectors for the storage of solar energy, and/or;
an optionally computer-controlled, electric driven solar circulation pump for the circulation of the heat transfer liquid through the solar collector;
an optionally computer-controlled, electric driven control valve to activate and deactivate the solar circulation of the heat transfer fluid;
sensors for internal and external temperatures for the optimization of the operating conditions and the maximization of the efficiency by means of a controlling computer, which optionally runs diagnostic functions and can optionally be remote-controlled via a modem.
